(19) United States
(12) Patent Application Publication
(10) Pub. No.: US 2011/0128195 A1
(43) Pub. Date: Jun. 2, 2011

(54) EMBEDDED ANTENNA OF WIRELESS DEVICE AND METHOD OF MANUFACTURING THEREOF

(76) Inventors: Byung Hoon Ryou, Seoul (KR); Won Mo Sung, Siheung-si (KR); Kang Hee Lee, Gimpo-si (KR)

(21) Appl. No.: 13/057,720

(22) PCT Filed: Aug. 5, 2009
(86) PCT No.: PCT/KR09/04364

§ 371 Date: Feb. 4, 2011

(30) Foreign Application Priority Data
Aug. 6, 2008 (KR) 10-2008-0077068

(51) Int. Cl. H01Q 1/24; H01Q 1/40; H01P 11/00

(52) U.S. Cl. 343/702; 29/600

(57) ABSTRACT

Disclosed is an embedded antenna of a wireless device that can be formed by pattern printing and a manufacturing method thereof. The embedded antenna of a wireless device according to the present invention comprises a substrate accommodated in the wireless device; a radiation unit printed on an inner surface of a housing of the wireless device and connected to the substrate, for transmitting and receiving electrical signals; and an insulation unit printed on the radiation unit, for insulating the radiation unit. Here, the radiation unit includes first and second radiators sequentially printed as a pattern on the inner surface of the housing, and the insulation unit includes first and second insulators printed to cover the first and second radiators in order. According to the configuration like this, since the radiation unit and the insulation unit can be formed to have a minimum thickness by pattern printing, the size of the embedded antenna embedded in the wireless device can be minimized.

### BACKGROUND OF THE INVENTION

1. Field of the Invention

The present invention relates to an embedded antenna, and more specifically, to an embedded antenna of a wireless device embedded in the wireless device by pattern printing, and a method of manufacturing thereof.

2. Background of the Related Art

In general, a wireless device is a general term for devices capable of transmitting and receiving information through wireless communications anywhere without being restricted by space, and it includes a cellular phone, a palm personal computer (PC), a personal digital assistant (PDA), a handheld PC (HPC), and the like. An antenna for wirelessly transmitting and receiving electronic information is installed in such a wireless device.

In an advanced society of today, distribution of wireless devices tends to abruptly increase due to rapid advancement of wireless communications. Accordingly, portability of such wireless devices is recognized as an important feature of the wireless devices.

The most typical method for improving portability of a wireless device is to provide a small-sized wireless device implemented by minimizing the volume of parts constructing the wireless device. Accordingly, the size of an antenna installed in the wireless device also tends to be reduced. Particularly, compact wireless devices provided with an embedded antenna installed in a wireless device are spread recently.

On the other hand, the embedded antenna comprises a radiator, an insulator, and a substrate for sending and receiving electrical signals on support of the radiator and the insulator and is installed in the wireless device. That is, the embedded antenna is manufactured outside of the wireless device and installed in the wireless device. Therefore, a separate process for assembling the embedded antenna within the wireless device is required.

In addition, thickness of the radiator, the insulator, and the substrate constructing the embedded antenna is a factor that hinders miniaturization of the embedded antenna, and as the thickness of the antenna decreases, the manufacturing cost is increased, and radiation performance is degraded.

Therefore, continuous studies on small-sized embedded antennas having a simple manufacturing process, a low manufacturing cost, and superior radiation performance are required.

### SUMMARY OF THE INVENTION

Accordingly, the present invention has been made in view of the above-mentioned problems occurring in the prior art, and it is an object of the present invention to provide an embedded antenna of a wireless device, which can be directly formed in a mobile communication terminal.

It is another object of the present invention to provide an embedded antenna of a wireless device, which has a low manufacturing cost and superior radiation performance.

It is still another object of the present invention to provide a method of manufacturing an embedded antenna of a wireless device, which has achieved the above objects.

To accomplish the above objects, according to an aspect of the present invention, there is provided an embedded antenna of a wireless device comprising: a substrate accommodated in the wireless device; a radiation unit printed on an inner surface of a housing of the wireless device and connected to the substrate, for transmitting and receiving electrical signals; and an insulation unit printed on the radiation unit, for insulating the radiation unit.

According to a preferred embodiment of the present invention, the radiation unit includes: a first radiator printed as a pattern on the inner surface of the housing; and a second radiator printed as a pattern on the insulation unit partially intervened to cover the first radiator, to be electrically connected to the first radiator. That is, the first and second radiators are printed with intervention of a portion of the insulation unit between the first and second radiators, and thus a double-side antenna is formed.

The insulation unit includes: a first insulator formed by printing an insulation material to cover the first radiator, and having a conductive hole for electrically connecting the first and second radiators to each other; and a second insulator formed by printing the insulation material to cover the second radiator.

The radiation unit and the insulation unit configured as described above can be sequentially printed in multiple layers in a modified embodiment.

According to another aspect of the present invention, there is provided an embedded antenna of a wireless device embedded in the wireless device to wirelessly transmit and receive electrical signals, and the embedded antenna comprises: a substrate provided in the wireless device; and a radiation section printed as a pattern on an inner surface of the wireless device to be connected to the substrate, for transmitting and receiving the electrical signals. Here, the radiation section includes: a radiator printed as a pattern on the inner surface of the wireless device; and an insulator printed to cover the radiator, for insulating the radiator.

To accomplish the above objects, according to another aspect of the present invention, there is provided a method of manufacturing an embedded antenna of a wireless device, the method comprising the steps of: providing a substrate in the wireless device; printing first and second radiators on an inner surface of a housing of the wireless device to be connected to the substrate and electrically connected to each other; and printing first and second insulators for insulating the first and second radiators respectively.

Specifically, the step of printing the first and second radiators includes the steps of: printing a pattern on the inner surface of the housing with a metallic paste; and metalizing the printed pattern by plating the printed pattern. At this point, it is preferable that the embedded antenna is implemented as a double-side antenna by printing the first and second radiators as a stack with intervention of the first insulator between the first and second radiators. To this end, a non-printed conductive hole is formed in the first insulator so that the first and second radiators can be electrically connected to each other.

The steps of printing the first and second radiators and printing the first and second insulators may be repeated sequentially multiple times.

According to another aspect of the present invention, there is provided a method of manufacturing an embedded antenna of a wireless device, the method comprising the steps of: providing a substrate in the wireless device; printing a first radiator as a pattern on an inner surface of the wireless device to be connected to the substrate; printing a first insulator to cover the first radiator; printing a second radiator as a pattern on the first insulator to be electrically connected to the first radiator and connected to the substrate; and printing a second insulator to cover the second radiator. At this point, a conductive hole is formed in the first insulator so that the first and second radiators can be electrically connected to each other.

The steps of printing the first radiator, printing the first insulator, printing the second radiator, and printing the second insulator may be repeated sequentially multiple times to implement a double-side antenna of multiple layers.

### BRIEF DESCRIPTION OF THE DRAWINGS

FIG. 1 is an exploded perspective view briefly showing a preferred embodiment of the present invention.

FIGS. 2 to 5 are plan views showing, in steps, a method of manufacturing the embedded antenna shown in FIG. 1.

FIG. 6 is a cross-sectional view taken along the line VI-VI to briefly show a connection state between a radiation unit in the housing and a substrate in the main body.

### DETAILED DESCRIPTION OF THE PREFERRED EMBODIMENT

Hereinafter, a preferred embodiment of the present invention will be described in detail with reference to the attached drawings.

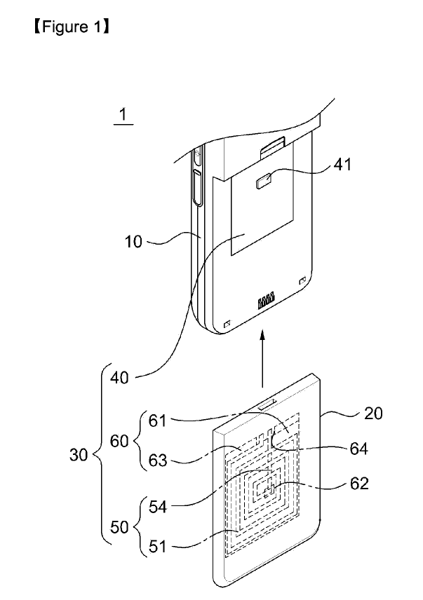

Referring to FIG. 1, an embedded antenna 30 of a wireless device 1 according to a preferred embodiment of the invention comprises a substrate 40, a radiation unit 50, and an insulation unit 60.

As shown in FIG. 1, the substrate 40 is provided in the main body 10 of the wireless device 1, and more specifically, inside the main body 10. Here, the substrate 40 controls electrical operation of the radiation unit 50 described below, and a connection pin 41 is prominently formed to be electronically connected to the radiation unit 50. The substrate includes a printed circuit board (PCB) on which a certain circuit pattern is printed.

Here, the radiation unit 50 is electrically connected to the substrate 40 and transmits and receives electrical signals. Here, the radiation unit 50 is printed on the inner surface of the wireless device 1, and more specifically, includes first and second radiators 51 and 54 printed on the inner surface 21 of the housing 20 of the wireless device 1.

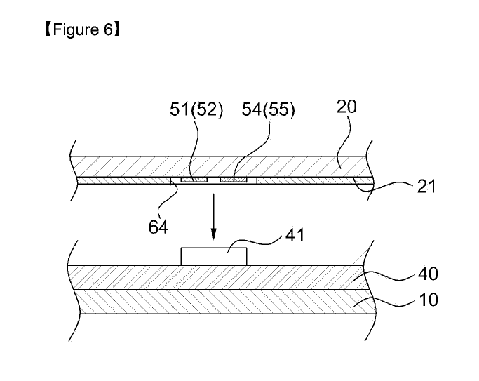

For reference, the housing 20 forms the external appearance of the wireless device 1 and includes an external case or cover. In the embodiment, as shown in FIGS. 1 and 6, the housing 20 can be detached from the main body 10, and an example of the housing is a cover, in which the radiation unit 50 can easily contact with the connection pin 41 of the substrate 40 when the housing 20 combines with the main body 10. The housing 20 is preferably formed of a non-conductive plastic material.

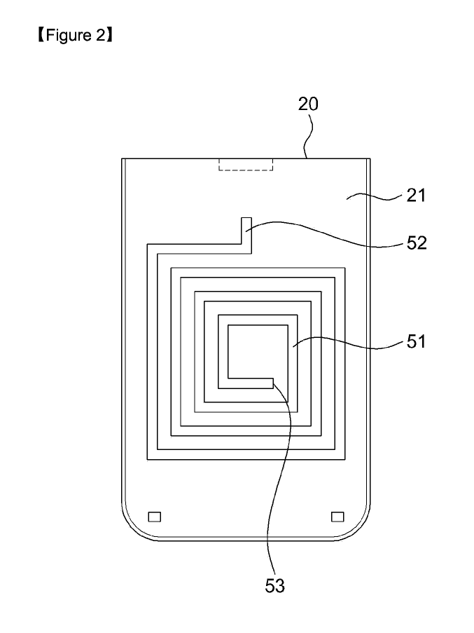

As shown in FIG. 2, the first radiator 51 is formed by printing a pattern on the inner surface 21 of the housing 20. Specifically, after a certain pattern is printed on the inner surface of the housing 20 with a metallic paste, the pattern is metalized by plating the printed pattern, and thus the first radiator 51 is formed to have a minimum thickness. At this point, a method of printing a pattern for forming the first radiator 51 can be implemented using any one of general printing methods, such as a pad printing method or a silk printing method.

On the other hand, although the first radiator 51 has a certain length, it is formed as a pattern that is bent a plurality of times like a whirlpool. Here, one end of the first radiator 51 is connected to the substrate 40, and the other end of the first radiator 51 is electrically connected to the second radiator 54 described below. Hereinafter, for the convenience of explanation, one end and the other end of the first radiator 51 are respectively referred to as a first connecting terminal 52 and a first conductive terminal 53.

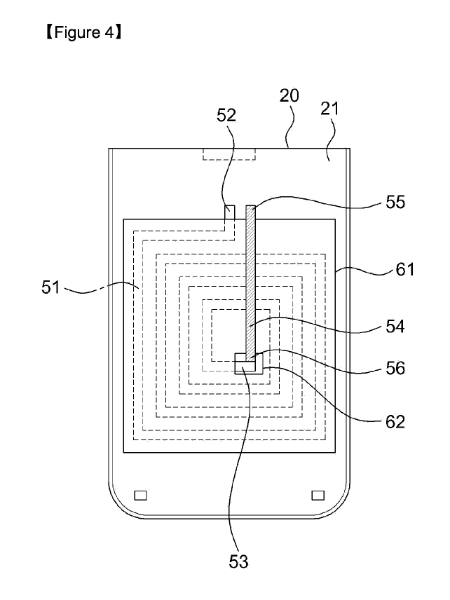

As shown in FIG. 4, the second radiator 54 is formed on the first radiator 51. Like the first radiator 51, after a pattern is printed with a metallic paste, the pattern is metalized by plating the printed pattern, and thus the second radiator 54 is formed to have a minimum thickness. At this point, although a first insulator 61 is intervened between the first and second radiators 51 and 54, the first insulator 61 will be described below together with the insulation unit 60.

The second radiator 54 is formed as a straight line having a certain length. At this point, one end of the second radiator 54 is a second connecting terminal 55 connected to the substrate 40, and the other end of the second radiator 54 is a second conductive terminal 56 electrically connected to the first radiator 54. Here, the first and second connecting terminals 52 and 55 are formed to be parallel to each other, and the first and second conductive terminals 53 and 56 are formed to be overlapped or contact with each other.

For reference, although it is described in the embodiment that the radiation patterns of the first and second radiators 51 and 54 are printed as a line bent a plurality of times and a straight line respectively, it is not limited thereto, and it is apparent that they can be printed in a variety of patterns depending on radiation characteristics.

The insulation unit 60 is printed to cover the radiation unit 50 and insulates the radiation unit 50. The insulation unit 60 includes first and second insulators 61 and 63 respectively corresponding to the first and second radiators 51 and 54.

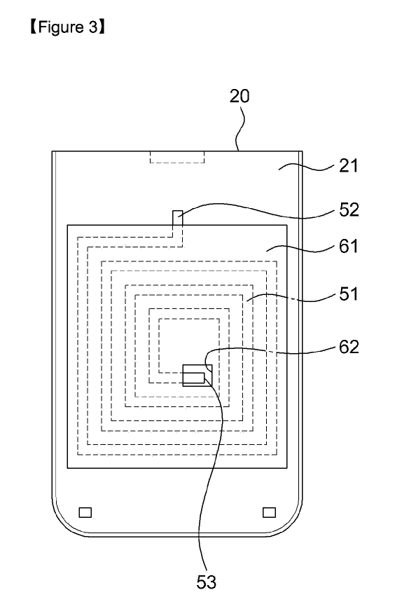

As described above, the first insulator 61 is formed between the first and second radiators 51 and 54 and insulates the first radiator 51 from the second radiator 54. Specifically, as shown in FIG. 3, the first insulator 61 is formed by printing an insulation material to cover the first radiator 51 and has a minimum thickness. In addition, the second radiator 54 is printed as a pattern on the first insulator 61.

At this point, although the first insulator 61 is printed to have an area that covers the entire area of the first radiator 51, it is formed to expose the first connecting terminal 52 and the first conductive terminal 53. To this end, although the first insulator 61 roughly has a rectangular area covering the first radiator 51 other than the first connecting terminal 52, a portion of the first insulator is open to form a conductive hole 62 for electrically connecting the first and second insulators 61 and 63 to each other.

A certain portion of the first insulator 61 is not printed when the first insulator 61 is printed, in order to form the conductive hole 62. Here, as shown in FIG. 4, the conductive hole 62 is formed at a position corresponding to the first and second conductive terminals 53 and 56 so that the first and second conductive terminals 53 and 56 of the first and second radiators 51 and 54 can be exposed.

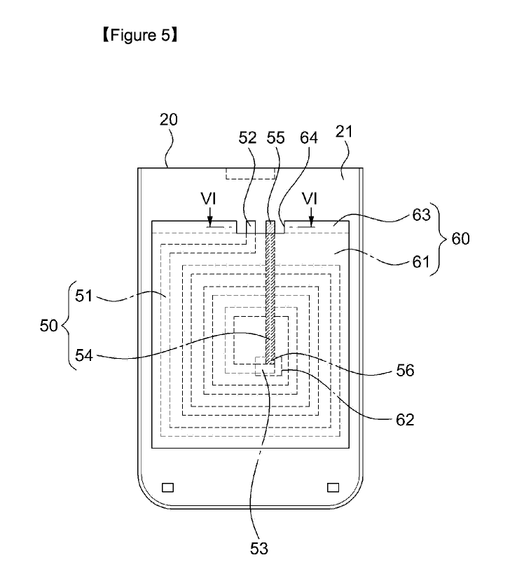

As shown in FIG. 5, like the first insulator 61, the second insulator 63 is formed by printing an insulation material to cover the second radiator 54 and has a minimum thickness. The second insulator 63 insulates the second radiator 54.

Here, since the second insulator 63 is formed to cover the second radiator 54 and has an area enough to cover the first insulator 61 as well, insulation efficiency of the first and second radiators 51 and 54 is greatly improved. At this point, a connecting groove 64 for exposing the first and second connecting terminals 52 and 55 of the first and second radiators 51 and 54 is formed in the second insulator 63. Like the conductive hole 62 formed in the first insulator 61, the connecting groove 64 is formed by non-printing of the insulation material. As shown in FIG. 6, since the first and second connecting terminals 52 and 55 of the first and second radiators 51 and 54 are exposed through the connecting groove 64, the first and second connecting terminals 52 and 55 can be electrically connected to the connection pin 41 of the substrate 40 provided in the main body 10 of the wireless device 1.

Based on the configuration described above, it is possible to implement a double-side antenna, in which the first and second radiators 51 and 54 are respectively formed on either side of the first insulator 61 intervening between the first and second radiators 51 and 54. Here, it is preferable that the total thickness of the first and second radiators 51 and 54 and the first and second insulators 61 and 63 is approximately less than 0.1 mm. The radiation unit 50 and the insulation unit 60 can be classified as a radiation section that transmits and receives electrical signals through electrical connection to the substrate 40.

A method of manufacturing an embedded antenna 30 of a wireless device 1 according to the present invention configured as described above will be described with reference to FIGS. 1 to 6.

First, as shown in FIG. 2, a first radiator 51 is formed by plating a pattern after the pattern is printed on the inner surface 21 of the housing 20. At this point, the first radiator 51 has a first connecting terminal 52 and a first conductive terminal 53 and is printed as a pattern that is bent a plurality of times. Then, as shown in FIG. 3, a first insulator 61 is formed by printing an insulation material to cover the area of the first radiator 51 other than the first connecting terminal 52. Here, a conductive hole 62 for exposing the first conductive terminal 53 is formed in the first insulator 61.

As shown in FIG. 4, a second radiator 54 is formed by plating a pattern after the pattern is printed on the first insulator 61 that is formed as described above. Here, the second radiator 54 is roughly formed as a straight line. A second connecting terminal 55, i.e., one end of the second radiator 54, is formed to be parallel to the first connecting terminal 52, and a second conductive terminal 56, i.e., the other end of the second radiator 54, is formed to be connected to the first conductive terminal 53 through the conductive hole 62.

If the second radiator 54 completes to be printed in this manner, a second insulator 63 is formed by printing an insulation material to cover the second radiator 54. At this point, the second insulator 63 is formed to include a connecting groove 64 for exposing the first and second connecting terminals 52 and 55 of the first and second radiators 51 and 54.

If the radiation unit 50 including the first and second radiators 51 and 54 and the insulation unit 60 including the first and second insulators 61 and 63 complete to be printed on the inner surface 21 of the housing 20, the housing 20 is combined with the main body 10 of the wireless device 1 as shown in FIG. 1. Accordingly, the connection pin 41 of the substrate provided in the main body 10 of the wireless device 1 is electrically connected to the first and second radiators 51 and 54 as shown in FIG. 6.

On the other hand, although it is described in the embodiment that the first radiator 51, the first insulator 61, the second radiator 54, and the second insulator 63 are sequentially printed as a stack just one time, it is not limited thereto. That is, it is apparent that a series of the above steps can be repeated a plurality of times to implement an embedded antenna 30 of multiple layers.

Although it is described in the embodiment that the first and second radiators 51 and 54 are respectively formed on either side of the first insulator 61 intervening between the first and second radiators 51 and 54, it is apparent that the first and second radiators 51 and 54 can be printed on the same surface of the housing 20 in a modified embodiment.

According to the present invention described above, first, an antenna can be directly formed in a wireless device by printing the antenna on the inner surface of the wireless device. Accordingly, a manufacturing process for embedding a separate antenna assembly in the wireless device is unnecessary, and thus the manufacturing process is simplified.

Second, since the radiation unit and the insulation unit constructing the antenna are formed by printing a pattern on the inner surface of the wireless device, thickness of the radiation unit and the insulation unit can be minimized. Accordingly, the wireless device can be miniaturized, and manufacturing cost can be reduced. Furthermore, although the radiation unit is formed to have a minimum thickness, reliability of radiation performance can be secured by the printed pattern.

Third, since the radiation unit and the insulation unit are formed in a housing detachable from the main body of the wireless device and connected to the substrate provided in the main body of the wireless device, the radiation unit and the substrate can be easily connected to each other when the housing is combined with the main body.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An embedded antenna of a wireless device, the antenna comprising:
a substrate accommodated in the wireless device;
a radiation unit printed on an inner surface of a housing of the wireless device and connected to the substrate, for transmitting and receiving electrical signals; and
an insulation unit printed on the radiation unit, for insulating the radiation unit.

2. The antenna according to claim 1, wherein the radiation unit includes:
a first radiator printed as a pattern on the inner surface of the housing; and
a second radiator printed as a pattern on the insulation unit partially intervened to cover the first radiator, to be electrically connected to the first radiator.

3. The antenna according to claim 2, wherein the insulation unit includes:
a first insulator formed by printing an insulation material to cover the first radiator, and having a conductive hole for electrically connecting the first and second radiators to each other; and
a second insulator formed by printing the insulation material to cover the second radiator.

4. The antenna according to Claim 1, wherein the radiation unit and the insulation unit are sequentially printed in multiple layers.

5. An embedded antenna embedded in a wireless device to wirelessly transmit and receive electrical signals, the embedded antenna comprising:
a substrate provided in the wireless device; and
a radiation section printed as a pattern on an inner surface of the wireless device to be connected to the substrate, for transmitting and receiving the electrical signals.

6. The antenna according to claim 5, wherein the radiation section comprises:
a radiator printed as a pattern on the inner surface of the wireless device; and
an insulator printed to cover the radiator, for insulating the radiator.

7. A method of manufacturing an embedded antenna of a wireless device, the method comprising:
providing a substrate in the wireless device;
printing first and second radiators on an inner surface of a housing of the wireless device to be connected to the substrate and electrically connected to each other; and
printing first and second insulators for insulating the first and second radiators respectively.

8. The method according to claim 7, wherein printing the first and second radiators comprises:
printing a pattern on the inner surface of the housing with a metallic paste; and
metalizing the printed pattern by plating the printed pattern.

9. The method according to claim 8, wherein the first and second radiators are printed as a stack with intervention of the first insulator between the first and second radiators.

10. The method according to claim 9, wherein a non-printed conductive hole is formed in the first insulator so that the first and second radiators can be electrically connected to each other.

11. The method according to claim 7, wherein printing the first and second radiators and printing the first and second insulators are repeated sequentially multiple times.

12. A method of manufacturing an embedded antenna of a wireless device, the method comprising:
providing a substrate in the wireless device;
printing a first radiator as a pattern on an inner surface of the wireless device to be connected to the substrate;
printing a first insulator to cover the first radiator;
printing a second radiator as a pattern on the first insulator to be electrically connected to the first radiator and connected to the substrate; and
printing a second insulator to cover the second radiator.

13. The method according to claim 12, wherein a conductive hole is formed in the first insulator so that the first and second radiators can be electrically connected to each other.

14. The method according to claim 12, wherein printing the first radiator, printing the first insulator, printing the second radiator, and printing the second insulator are repeated sequentially multiple times.
